(19) United States
(12) Patent Application Publication
(10) Pub. No.: US 2012/0127303 A1
(43) Pub. Date: May 24, 2012

(54) Detecting System Component Failures In A Computing System

(75) Inventors: Paul D. Kangas, Raleigh, NC (US); Daniel M. Ranck, Cary, NC (US)

(73) Assignee: INTERNATIONAL BUSINESS MACHINES CORPORATION, Armonk, NY (US)

(21) Appl. No.: 12/950,208

(22) Filed: Nov. 19, 2010

(51) Int. Cl. H04N 7/18

(52) U.S. Cl. 348/135; 348/E07.085

(57) ABSTRACT

Detecting system component failures in a computing system, including: capturing, by a digital imaging device, a plurality of time sequenced images of a component in the computing system; comparing, by a digital imaging comparator, the plurality of time sequenced images of the component in the computing system; determining, by the digital imaging comparator, whether the plurality of time sequenced images of the component in the computing system have changed more than a predetermined threshold; and sending, by a notification system, a component alert notification upon determining that the plurality of time sequenced images of the component in the computing system have changed more than the predetermined threshold.

### BACKGROUND OF THE INVENTION

1. Field of the Invention

The field of the invention is data processing, or, more specifically, methods, apparatus, and products for detecting system component failures in a computing system.

2. Description Of Related Art

Modern computing systems are composed of many parts of varying complexity. In such computing systems, parts can fail, parts can be improperly configured, and the performance of such computing systems can be severely limited as a consequence. Traditional computing system diagnostics with human intervention is costly and pervasive techniques for remote trouble shooting are still very limited.

### SUMMARY OF THE INVENTION

Methods, apparatus, and products for detecting system component failures in a computing system, including: capturing, by a digital imaging device, a plurality of time sequenced images of a component in the computing system; comparing, by a digital imaging comparator, the plurality of time sequenced images of the component in the computing system; determining, by the digital imaging comparator, that the plurality of time sequenced images of the component in the computing system have changed more than a predetermined threshold; and sending, by a notification system, a component alert notification upon determining that the plurality of time sequenced images of the component in the computing system have changed more than the predetermined threshold.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an example computer useful in detecting system component failures in a computing system according to embodiments of the present invention.

FIG. 2 sets forth a flow chart illustrating an example method for detecting system component failures in a computing system according to embodiments of the present invention.

FIG. 3 sets forth a flow chart illustrating an example method for detecting system component failures in a computing system according to embodiments of the present invention.

FIG. 4 sets forth a flow chart illustrating an example method for detecting system component failures in a computing system according to embodiments of the present invention.

### DETAILED DESCRIPTION OF EXEMPLARY EMBODIMENTS

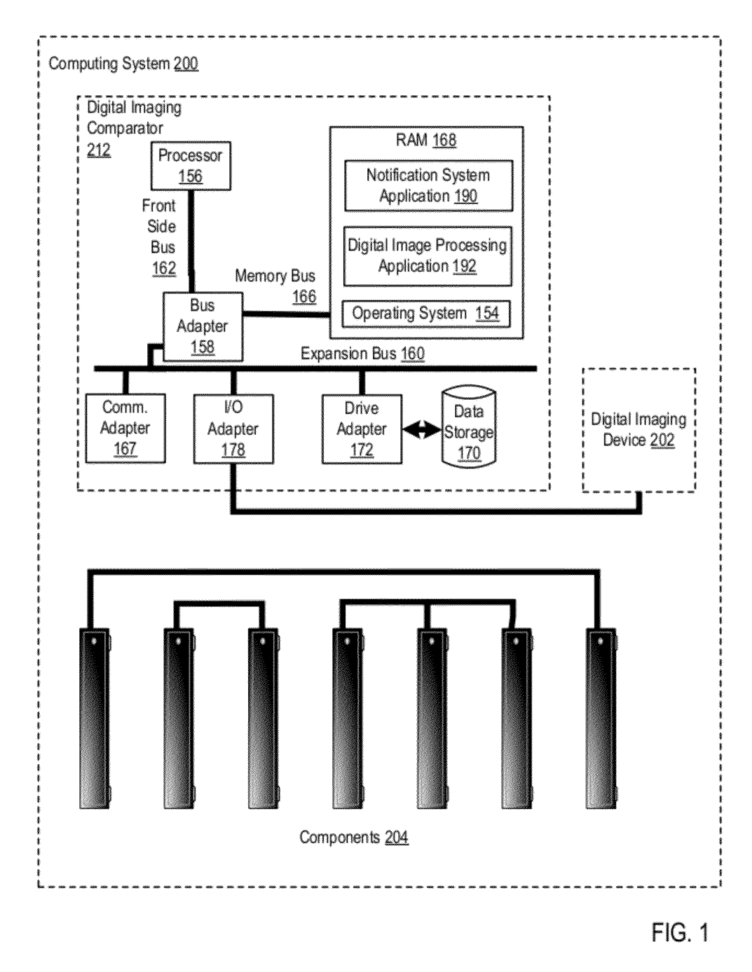

Exemplary methods, apparatus, and products for detecting system component failures in a computing system in accordance with the present invention are described with reference to the accompanying drawings, beginning with FIG. 1. Detecting system component failures in a computing system in accordance with the present invention is generally implemented with computers, that is, with automated computing machinery. For further explanation, therefore, FIG. 1 sets forth a block diagram of automated computing machinery comprising an example computing system (200) in which system component (204) failures are identified according to embodiments of the present invention.

The computing system (200) of FIG. 1 includes a one or more components (204). In the example of FIG. 1, a component (204) is any physical entity that is part of the computing system (200). In the example of FIG. 1, a component (204) may be embodied as a server, a port, a cable, a power supply, a transistor, a capacitor, a heat sink, and the like.

The computing system (200) of FIG. 1 also includes a digital imaging device (202). In the example of FIG. 1, the digital imaging device (202) is any device capable of capturing digital images. The digital imaging device (202) may be embodied as a digital camera, digital video camera, or other image sensor. Examples of image sensors include devices that include an integrated charge-coupled device (‘CCD’), active-pixel sensor (‘APS’), or complementary metal-oxide-semiconductor (‘CMOS’) sensor.

The computing system (200) of FIG. 1 also includes a digital imaging comparator (212). In the example of FIG. 1, the digital imaging comparator (212) is a module of automated computing machinery that compares one digital image to another digital image to determine the extent to which the digital images are similar. The digital imaging comparator (212) of FIG. 1 includes at least one computer processor (156) or ‘CPU’ as well as random access memory (168) (‘RAM’) which is connected through a high speed memory bus (166) and bus adapter (158) to processor (156) and to other components of the digital imaging comparator (212).

Stored in RAM (168) is a digital imaging processing application (192), a module of computer program instructions for comparing one digital image to another digital image to determine the extent to which the digital images are similar. Also stored in RAM (168) is a notification system application (190), a module of computer program instructions for generating and facilitating the transmission of component alert notifications indicating that a particular component (204) in the computing system (200) is improperly configured, is malfunctioning, is in need of attention, and so on. Also stored in RAM (168) is an operating system (154). Operating systems useful in detecting system component failures in a computing system according to embodiments of the present invention include UNIX™, Linux™, Microsoft XP™, AIX™, IBM's i5/OS™, and others as will occur to those of skill in the art. The operating system (154), the digital imaging processing application (192), and the notification system application (190) in the example of FIG. 1 are shown in RAM (168), but many components of such software typically are stored in non-volatile memory also, such as, for example, on a disk drive (170).

The digital imaging comparator (212) of FIG. 1 includes disk drive adapter (172) coupled through expansion bus (160) and bus adapter (158) to processor (156) and other components of the digital imaging comparator (212). Disk drive adapter (172) connects non-volatile data storage to the digital imaging comparator (212) in the form of disk drive (170). Disk drive adapters useful in computers for detecting system component failures in a computing system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example digital imaging comparator (212) of FIG. 1 includes one or more input/output (‘I/O’) adapters (178). I/O adapters implement user-oriented input/output through, for example, the digital imaging device (202), software drivers and computer hardware for controlling output to display devices such as computer display screens, as well as user input from user input devices (181) such as keyboards and mice. In the example of FIG. 1, the digital imaging comparator (212) receives input from the digital imaging device (202) in the form of digital images captured by the digital imaging device (202).

The example digital imaging comparator (212) of FIG. 1 includes a communications adapter (167) for data communications with other devices, such as other components (204) in the computing system (200) and for data communications with a data communications network. In particular, the digital imaging comparator (212) is coupled for data communications with data communications networks for the transmission of failure event notifications to a system administrator or other entity that monitors the computing system (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for detecting system component failures in a computing system according to embodiments of the present invention include modems for wired dial-up communications, Ethernet (IEEE 802.3) adapters for wired data communications network communications, and 802.11 adapters for wireless data communications network communications.

In the example of FIG. 1, the digital imaging comparator (212) and the digital imaging device (202) are depicted as being separate devices. Readers will appreciate that the digital imaging comparator (212) and the digital imaging device (202) may be embodied, for example, as modules within a single computing device. In the example of FIG. 1, the digital imaging comparator (212) is illustrated as including the notification system application (190). Readers will appreciate that the digital imaging comparator (212) and the notification system application (190) may reside on separate machines as well. That is, the digital imaging comparator (212), digital imaging device (202), and notification system application (190) may all reside on a single computing device or on distinct computing devices.

In the example of FIG. 1, system component (204) failures are detected in the computing system (200) by capturing, by the digital imaging device (202), a plurality of time sequenced images of a component (204) in the computing system (200); comparing, by the digital imaging comparator (212), the plurality of time sequenced images of the component (204) in the computing system (200); determining, by the digital imaging comparator (212), whether the plurality of time sequenced images of the component (204) in the computing system (200) have changed more than a predetermined threshold; and sending, by a notification system application (190), a component alert notification upon determining that the plurality of time sequenced images of the component (204) in the computing system (200) have changed more than the predetermined threshold.

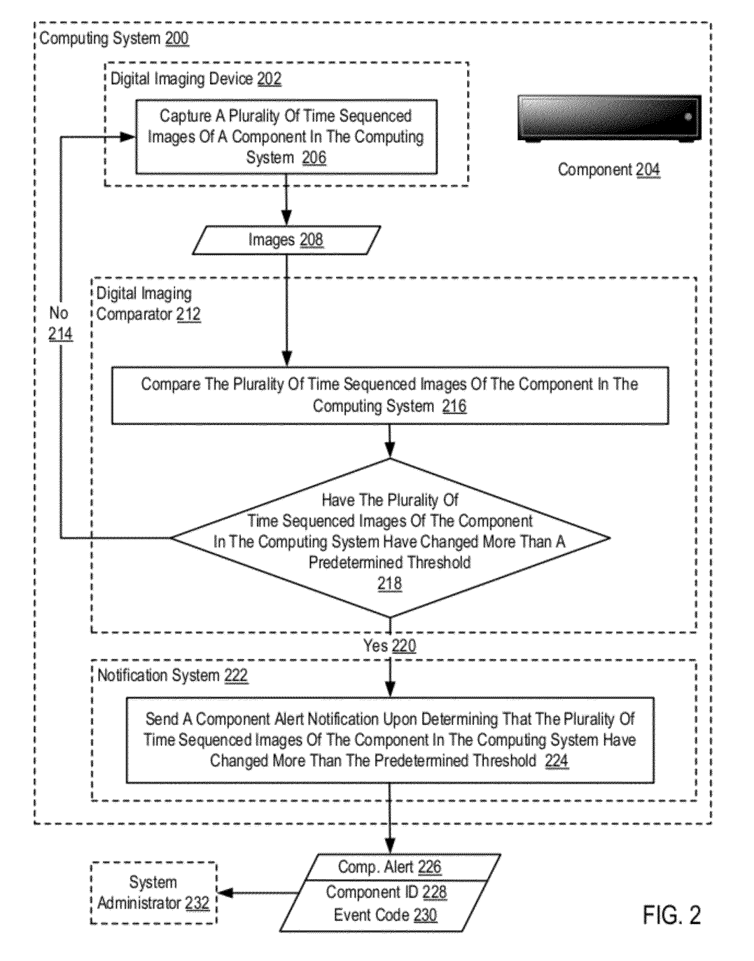

For further explanation, FIG. 2 sets forth a flow chart illustrating an example method for detecting system component failures in a computing system (200) according to embodiments of the present invention that includes capturing (206), by a digital imaging device (202), a plurality of time sequenced images (208) of a component (204) in the computing system (200). A digital imaging device (202) is any device capable of capturing digital images. In the example of FIG. 2, the digital imaging device (202) may be embodied as a digital camera, digital video camera, or other image sensor. Examples of image sensors include devices that include an integrated CCD, APS, or CMOS sensor. A component (204) is any physical entity that is part of the computing system (200). In the example of FIG. 2, a component (204) may be embodied as a server, a port, a cable, a power supply, a transistor, and the like.

In the example of FIG. 2, capturing (206), by a digital imaging device (202), a plurality of time sequenced images (208) of a component (204) in the computing system (200) can be carried out, for example, by an image sensor that captures and converts an optical image to an electrical signal. In such an embodiment, when light strikes each pixel in the image sensor, the light is held as an electrical charge that is converted to a voltage and subsequently into digital information. The collection of digital information that represents the amount of light that struck each pixel is stored as a single digital image. By repeating this process, for example, upon user request, at random periods of time, or in predefined intervals, a plurality of time sequenced images (208) of a component (204) in the computing system (200) can be captured (206). Upon capturing (206) the time sequenced images (208), the time sequenced images (208) are sent to or otherwise made available to a digital image comparator (212). In the example of FIG. 2, the time sequenced images (208) may be stored in computer memory that is included as part of the digital imaging device (202) or stored in computer memory that is accessible by but distinct from the digital imaging device (202).

The example of FIG. 2 also includes comparing (216), by a digital imaging comparator (212), the plurality of time sequenced images (208) of the component (204) in the computing system (200). In the example of FIG. 2, the digital imaging comparator (212) is a module of automated computing machinery that compares one digital image to another digital image to determine the extent to which the digital images are similar. The digital imaging comparator (212) of FIG. 2 may be embodied as computer hardware executing digital image processing computer software.

In the example of FIG. 2, the digital imaging comparator (212) may compare the plurality of time sequenced images (208) to each other using a digital imaging algorithm to determine the extent to which each time sequenced images (208) are similar. Such a digital imaging algorithm may include, for example, comparing the images on a pixel by pixel basis to determine how similar the image data for each pixel is, to determine the amount of pixels that are identical, to determine an average deviation between the pixels, and so on. The extent to which two pixels are identical may be determined, for example, based on the RGB color level of each pixel, based on the grayscale intensity level of each pixel, and so on. Useful digital imaging algorithms and techniques include, for example, pixelization techniques, linear filtering techniques, principal component analysis techniques, and independent component analysis techniques.

The example of FIG. 2 also includes determining (218), by the digital imaging comparator (212), whether the plurality of time sequenced images (208) of the component (204) in the computing system (200) have changed more than a predetermined threshold. In the example of FIG. 2, determining (218) whether the plurality of time sequenced images (208) of the component (204) in the computing system (200) have changed more than a predetermined threshold may be carried out, for example, by examining particular pixels within each of the plurality of time sequenced images (208) to determine whether color properties of each pixel have changed more than a predetermined threshold.

For example, a particular range of pixels in each of the plurality of time sequenced images (208) may include images of a heat sink in the computing system. The first image in the plurality of time sequenced images (208) may depict the heat sink when it is clean, such that the pixels in the image that depict the heat sink have an initial grayscale intensity level. Over time, as the heat sink collects dust, the grayscale intensity level of the pixels in the image that depict the heat sink will increase as the heat sink collects dust. A predetermined threshold may therefore be set such that once the grayscale intensity level of the pixels in the image that depict the heat sink increase beyond a certain point, the heat sink is deemed to be dirty and ineffective for its intended purpose of removing heat from the computing system (200). In such an example, determining (218) whether the plurality of time sequenced images (208) of the component (204) in the computing system (200) have changed more than a predetermined threshold may be carried out by recording the grayscale intensity level of the pixels in the image that depict the heat sink when it is clean and inspecting each image of the plurality of time sequenced images (208) to determine whether the grayscale intensity level of the pixels that depict the heat sink in the subsequent images have intensified by more than the predetermined threshold amount.

In the example of FIG. 2, when it is determined that the plurality of time sequenced images (208) have not (214) changed more than a predetermined threshold, the method depicted in FIG. 2 returns flow control to the digital imaging device (202) which will subsequently captures (206) additional time sequenced images (208) of the component (204). Alternatively, when it is determined that the plurality of time sequenced images (208) have (220) changed more than a predetermined threshold, the method depicted in FIG. 2 includes sending (224), by a notification system (222), a component alert notification (226) upon determining that the plurality of time sequenced images (208) of the component (204) in the computing system (200) have changed more than the predetermined threshold. The notification system (222) of FIG. 2 is automated computing machinery capable of communicating with a notification receipt such as, for example, a system administrator (232), an error log, a notification repository, and so on.

In the example of FIG. 2, sending (224), by the notification system (222), a component alert notification (226) upon determining that the plurality of time sequenced images (208) of the component (204) in the computing system (200) have changed more than the predetermined threshold may be carried out, for example, by constructing an email message, a short message service (‘SMS’) message, an instant message, or other form of message over an appropriate data communications network to the system administrator (232). In the example of FIG. 2, the component alert notification (226) includes an identification (228) of the component (204) captured in the plurality of time sequenced images (208) and an event code (230) identifying an alert type. For example, the component alert notification (226) may include an identification (228) representing a particular heat sink and an event code (230) that indicates that the heat sink is covered in an unacceptable amount of dust. Such a component alert notification (226) may be used, for example, by the system administrator (232) to identify a problem in the computing system (200) so that the system administrator (232) can take a corrective action such as cleaning the heat sink.

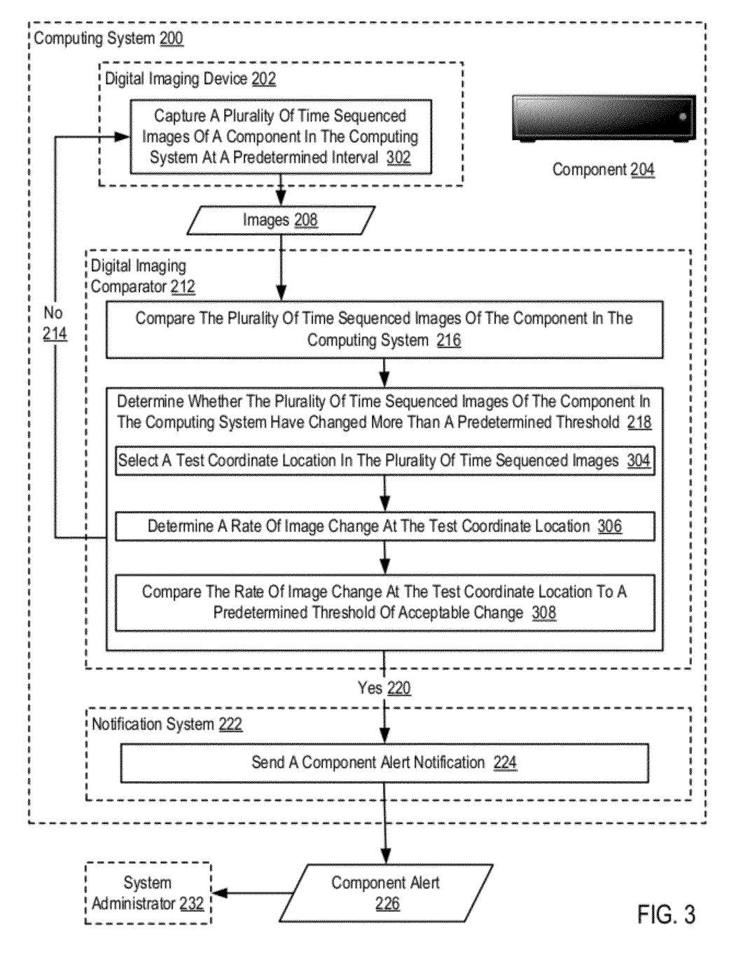

For further explanation, FIG. 3 sets forth a flow chart illustrating a further exemplary method for detecting system component failures in a computing system according to embodiments of the present invention. The example of FIG. 3 is similar to the example of FIG. 2 as it also includes:
comparing (216), by a digital imaging comparator (212), a plurality of time sequenced images (208) of the component (204) in the computing system (200),
determining (218), by the digital imaging comparator (212), whether the plurality of time sequenced images (208) of the component (204) in the computing system (200) have changed more than a predetermined threshold, and
sending (224), by a notification system (222), a component alert notification (226) upon determining that the plurality of time sequenced images (208) of the component (204) in the computing system (200) have changed more than the predetermined threshold.

The example of FIG. 3 also includes capturing (302) the plurality of time sequenced images (208) of the component (204) in the computing system (200) at a predetermined interval. In the example of FIG. 3, the predetermined interval may be embodied, for example, as an amount of time, as a number of images to be captured within a period of time, and so on. Although the example of FIG. 3 depicts only a single digital imaging device (202), readers will appreciate that embodiments of the present invention may include multiple digital imaging devices such that multiple views of a single component (204) may be captured (302). Embodiments of the present invention may therefore capture (302) the plurality of time sequenced images (208) of the component (204) from multiple perspectives using multiple digital imaging devices.

In the example of FIG. 3, determining (218), by the digital imaging comparator (212), that the plurality of time sequenced images (208) of the component (204) in the computing system (200) have changed more than a predetermined threshold includes selecting (304) a test coordinate location in the plurality of time sequenced images (208). In the example of FIG. 3, a test coordinate location in the plurality of time sequenced images (208) may be embodied, for example, as a range of pixels in the plurality of time sequenced images (208). A test coordinate location may be selected (304), for example, based on the placement of a particular component (204) within the computing system (200).

Because the digital imaging device (202) of FIG. 3 is located in a static position relative to the computing system (200), images captured by the digital imaging device (202) will depict the same components at the same locations within each of the time sequenced images (208). As such, only a portion of each of the time sequenced images (208) may need to be inspected in order to monitor a particular component (204) within the computing system (200). For example, to monitor a heat sink within the computing system (200), the same pixels can be examined within each of the plurality of time sequenced images (208)—the pixels in each of the plurality of time sequenced images (208) that contain an image of the heat sink. In such an example, a test coordinate location in the plurality of time sequenced images (208) would be selected (304) that corresponds to the range of pixels in each of the plurality of time sequenced images (208) that contain an image of the heat sink.

In the example of FIG. 3, determining (218), by the digital imaging comparator (212), that the plurality of time sequenced images (208) of the component (204) in the computing system (200) have changed more than a predetermined threshold also includes determining (306) a rate of image change at the test coordinate location. In the example of FIG. 3, determining (306) a rate of image change at the test coordinate location may be carried out, for example, by inspecting the pixels that form the test coordinate location in each of the plurality of time sequenced images (208) to determine the extent to which the pixels have changed.

For example, a test coordinate location in the plurality of time sequenced images (208) may be selected (304) that corresponds to the range of pixels in each of the plurality of time sequenced images (208) that contain an image of a heat sink to be monitored. In such an example, determining (306) a rate of image change at the test coordinate location may be carried out, for example, by determining that rate at which the grayscale intensity level of the pixels is increasing as a result of the accumulation of dust on the heat sink. The rate of image change at the test coordinate location may therefore be expressed, as a percentage indicating the average increase in grayscale intensity level of the pixels in each image, as a percentage indicating the average increase in grayscale intensity level of the pixels per unit of time, and so on.

In the example of FIG. 3, determining (218), by the digital imaging comparator (212), that the plurality of time sequenced images (208) of the component (204) in the computing system (200) have changed more than a predetermined threshold also includes comparing (308) the rate of image change at the test coordinate location to a predetermined threshold of acceptable change. In the example of FIG. 3, if the rate of image change at the test coordinate location is less than (214) the predetermined threshold of acceptable change, flow control is returned to the digital imaging device (202) to capture additional images. If the rate of image change at the test coordinate location is greater than (220) the predetermined threshold of acceptable change, however, a component alert notification (226) is sent (224) by the notification system (222).

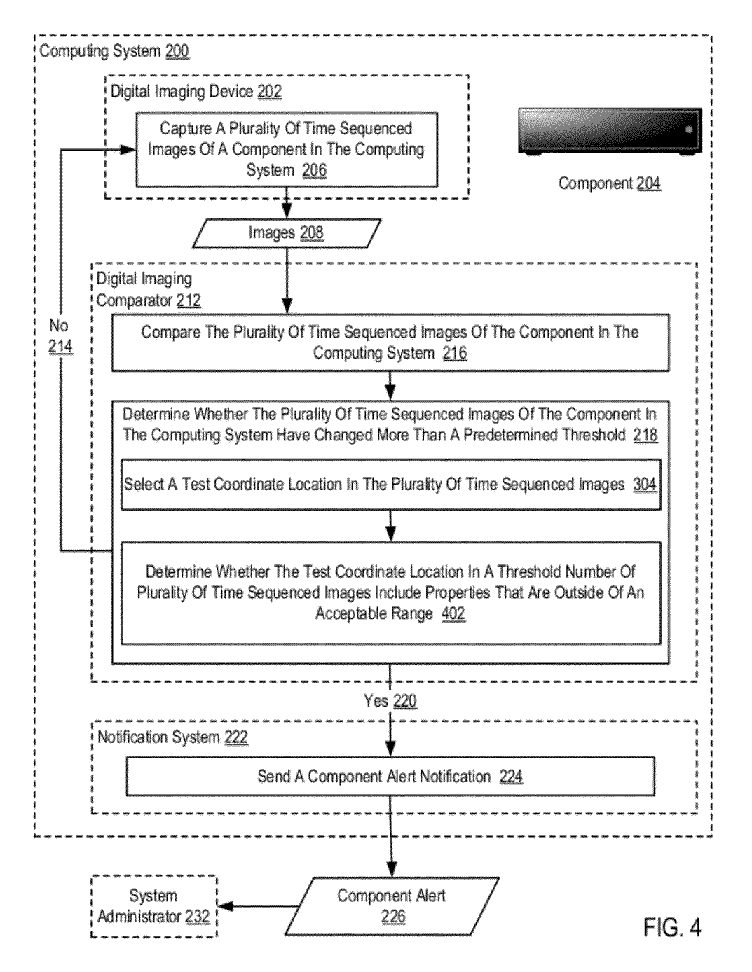

For further explanation, FIG. 4 sets forth a flow chart illustrating a further exemplary method for detecting system component failures in a computing system according to embodiments of the present invention. The example of FIG. 4 is similar to the examples of FIG. 2 and FIG. 3 as it also includes:
capturing (206), by a digital imaging device (202), a plurality of time sequenced images (208) of a component (204) in the computing system (200),
comparing (216), by a digital imaging comparator (212), a plurality of time sequenced images (208) of the component (204) in the computing system (200),
determining (218), by the digital imaging comparator (212), whether the plurality of time sequenced images (208) of the component (204) in the computing system (200) have changed more than a predetermined threshold, and
sending (224), by a notification system (222), a component alert notification (226) upon determining that the plurality of time sequenced images (208) of the component (204) in the computing system (200) have changed more than the predetermined threshold.

In the example of FIG. 4, determining (218), by the digital imaging comparator (212), whether the plurality of time sequenced images (208) of the component (204) in the computing system (200) have changed more than a predetermined threshold includes selecting (304) a test coordinate location in the plurality of time sequenced images. In the example of FIG. 4, a test coordinate location in the plurality of time sequenced images (208) may be embodied, for example, as a range of pixels in the plurality of time sequenced images (208). A test coordinate location may be selected (304), for example, based on the placement of a particular component (204) within the computing system (200).

Because the digital imaging device (202) of FIG. 4 is located in a static position relative to the computing system (200), images captured by the digital imaging device (202) will depict the same components at the same locations within each of the time sequenced images (208). As such, only a portion of each of the time sequenced images (208) may need to be inspected in order to monitor a particular component (204) within the computing system (200). For example, to monitor a heat sink within the computing system (200), the same pixels can be examined within each of the plurality of time sequenced images (208)—the pixels in each of the plurality of time sequenced images (208) that contain an image of the heat sink. In such an example, a test coordinate location in the plurality of time sequenced images (208) would be selected (304) that corresponds to the range of pixels in each of the plurality of time sequenced images (208) that contain an image of the heat sink.

In the example of FIG. 4, determining (218), by the digital imaging comparator (212), whether the plurality of time sequenced images (208) of the component (204) in the computing system (200) have changed more than a predetermined threshold also includes determining (402) whether the test coordinate location in a threshold number of plurality of time sequenced images (208) include properties that are outside of an acceptable range. In the example of FIG. 4, determining (402) whether the test coordinate location in a threshold number of plurality of time sequenced images (208) include properties that are outside of an acceptable range may be carried out, for example, by inspecting the pixels that form the test coordinate location in each of the plurality of time sequenced images (208) to determine whether properties of those pixels are outside of an acceptable range.

For example, a test coordinate location in the plurality of time sequenced images (208) may be selected (304) that corresponds to the range of pixels in each of the plurality of time sequenced images (208) that contain an image of a heat sink to be monitored. In such an example, determining (402) whether the test coordinate location in a threshold number of plurality of time sequenced images (208) include properties that are outside of an acceptable range may be carried out, for example, by determining the grayscale intensity level of the pixels that contain an image of the heat sink and comparing the grayscale intensity level of such pixels to a predetermined grayscale intensity level corresponding to an image of a heat sink that is covered in too much dust.

In the example of FIG. 4, if a threshold number of plurality of time sequenced images (208) include properties that are not (214) outside of an acceptable range, flow control is returned to the digital imaging device (202) to capture additional images. If a threshold number of plurality of time sequenced images (208) include properties that are (220) outside of an acceptable range, however, a component alert notification (226) is sent (224) by the notification system (222).

Exemplary embodiments of the present invention are described largely in the context of a fully functional computer system for detecting system component failures in a computing system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of detecting system component failures in a computing system, the method comprising:
capturing, by a digital imaging device, a plurality of time sequenced images of a component in the computing system;
comparing, by a digital imaging comparator, the plurality of time sequenced images of the component in the computing system;
determining, by the digital imaging comparator, whether the plurality of time sequenced images of the component in the computing system have changed more than a predetermined threshold; and
sending, by a notification system, a component alert notification upon determining that the plurality of time sequenced images of the component in the computing system have changed more than the predetermined threshold.

2. The method of claim 1, wherein the component alert notification includes an identification of the component and an event code identifying an alert type.

3. The method of claim 1 wherein capturing the plurality of time sequenced images of the component in the computing system further comprises capturing images of the component at a predetermined interval.

4. The method of claim 1 wherein determining, by the digital imaging comparator, that the plurality of time sequenced images of the component in the computing system have changed more than a predetermined threshold further comprises:
selecting a test coordinate location in the plurality of time sequenced images;
determining a rate of image change at the test coordinate location; and
comparing the rate of image change at the test coordinate location to a predetermined threshold of acceptable change.

5. The method of claim 1 wherein determining, by the digital imaging comparator, that the plurality of time sequenced images of the component in the computing system have changed more than a predetermined threshold further comprises:
selecting a test coordinate location in the plurality of time sequenced images; and
determining whether the test coordinate location in a threshold number of plurality of time sequenced images include properties that are outside of an acceptable range.

6. Apparatus for detecting system component failures in a computing system, the apparatus comprising a computer processor, a computer memory operatively coupled to the computer processor, the computer memory having disposed within it computer program instructions that, when executed by the computer processor, cause the apparatus to carry out the steps of:
capturing, by a digital imaging device, a plurality of time sequenced images of a component in the computing system;
comparing, by a digital imaging comparator, the plurality of time sequenced images of the component in the computing system;
determining, by the digital imaging comparator, whether the plurality of time sequenced images of the component in the computing system have changed more than a predetermined threshold; and
sending, by a notification system, a component alert notification upon determining that the plurality of time sequenced images of the component in the computing system have changed more than the predetermined threshold.

7. The apparatus of claim 6 wherein the component alert notification includes an identification of the component and an event code identifying an alert type.

8. The apparatus of claim 6 wherein capturing the plurality of time sequenced images of the component in the computing system further comprises capturing images of the component at a predetermined interval.

9. The apparatus of claim 6 wherein determining, by the digital imaging comparator, that the plurality of time sequenced images of the component in the computing system have changed more than a predetermined threshold further comprises:
selecting a test coordinate location in the plurality of time sequenced images;
determining a rate of image change at the test coordinate location; and
comparing the rate of image change at the test coordinate location to a predetermined threshold of acceptable change.

10. The apparatus of claim 6 wherein determining, by the digital imaging comparator, that the plurality of time sequenced images of the component in the computing system have changed more than a predetermined threshold further comprises:
selecting a test coordinate location in the plurality of time sequenced images; and
determining whether the test coordinate location in a threshold number of plurality of time sequenced images include properties that are outside of an acceptable range.

11. A computer program product for detecting system component failures in a computing system, the computer program product disposed upon a computer readable storage medium, the computer program product comprising computer program instructions that, when executed, cause a computer to carry out the steps of:
capturing, by a digital imaging device, a plurality of time sequenced images of a component in the computing system;
comparing, by a digital imaging comparator, the plurality of time sequenced images of the component in the computing system;
determining, by the digital imaging comparator, whether the plurality of time sequenced images of the component in the computing system have changed more than a predetermined threshold; and
sending, by a notification system, a component alert notification upon determining that the plurality of time sequenced images of the component in the computing system have changed more than the predetermined threshold.

12. The computer program product of claim 11 wherein the component alert notification includes an identification of the component and an event code identifying an alert type.

13. The computer program product of claim 11 wherein capturing the plurality of time sequenced images of the component in the computing system further comprises capturing images of the component at a predetermined interval.

14. The computer program product of claim 11 wherein determining, by the digital imaging comparator, that the plurality of time sequenced images of the component in the computing system have changed more than a predetermined threshold further comprises:
selecting a test coordinate location in the plurality of time sequenced images;
determining a rate of image change at the test coordinate location; and
comparing the rate of image change at the test coordinate location to a predetermined threshold of acceptable change.

15. The computer program product of claim 11 wherein determining, by the digital imaging comparator, that the plurality of time sequenced images of the component in the computing system have changed more than a predetermined threshold further comprises:
selecting a test coordinate location in the plurality of time sequenced images; and
determining whether the test coordinate location in a threshold number of plurality of time sequenced images include properties that are outside of an acceptable range.
